(19) United States
(12) Patent Application Publication
(10) Pub. No.: US 2005/0259188 A1
(43) Pub. Date: Nov. 24, 2005

(54) Projection television

(76) Inventor: Sung-soo Jung, Suwon-si (KR)

Correspondence Address: STANZIONE & KIM, LLP, 919 18TH STREET, N.W., SUITE 440, WASHINGTON, DC, 20006, US

(21) Appl. No.: 11/134,342

(22) Filed: May 23, 2005

(30) Foreign Application Priority Data
May 24, 2004 (KR) 2004-37025
Jul. 26, 2004 (KR) 2004-58249

(51) Int. Cl. H04N 5/74

(52) U.S. Cl. 348/787; 348/778

(57) ABSTRACT

A projection television including a cathode ray tube (CRT) assembly, and a screen to form an image thereon by an image beam projected from the CRT assembly, the CRT assembly including a plurality of RGB CRTs arranged in a delta-type; a plurality of projection lenses respectively provided in front of each of the RGB CRTs; and a coupler provided between each of the RGB CRTs and each corresponding projection lens to accommodate a first, a second and a third coolant accommodators corresponding to each of the RGB CRTs, wherein at least one of the first, the second and the third coolant accommodators includes a coolant injection port, and the other coolant accommodators respectively include coolant communication holes to communicate with the coolant accommodator in which the coolant injection port is provided. The projection television simplifies a structure of a coupler, and enables light of red, green and blue of a cathode ray tube (CRT) assembly to be efficiently distributed over a screen.

### CROSS-REFERENCE TO RELATED APPLICATIONS

This application claims the benefit of Korean Patent Application Nos. 2004-37025 filed on May 24, 2004 and 2004-58249 filed on Jul. 26, 2004 in the Korean Intellectual Property Office, the disclosure of which is incorporated herein by reference.

### BACKGROUND OF THE INVENTION

1. Field of the Invention

The present general inventive concept relates to a projection television, and more particularly, to a projection television displaying an image through a cathode ray tube (CRT) assembly on a screen.

2. Description of the Related Art

Generally, a projection television employs an optical device such as a projector, and projects an image beam to a rear surface of a screen to form an image.

Especially, the projection television has an advantage of enlarging the screen, and thus its demand is increased.

As shown in FIG. 1, a conventional projection television comprises a screen 1; a mask 2 supporting the screen 1; a casing 3 coupled to a rear side of the mask 2; a reflection mirror 4 provided in an inner rear portion of the casing 3; and a CRT assembly 5 provided in a lower portion of the casing 3 and projecting an image beam to the reflection mirror 4. Thus, the image beam projected to the reflection mirror 4 from the CRT assembly 5 is reflected forward so as to display the image on the screen 1.

However, the conventional projection television has a problem of displaying a seriously distorted image because cathode ray tubes in the CRT assembly 5 are arranged side by side and thus the image beam cannot be vertically projected to the screen 1. Accordingly, to make the image displayed on the screen 1 so as to be matched with the rectangular screen 1, an amount of electric current introduced to a deflection coil is increased resulting in an increase of power consumption as well as heat generation.

Recently, a CRT assembly structured to a delta-type has been developed to solve the foregoing problem of the conventional projection television, but it is accompanied by a coupler to support a cathode ray tube (CRT) and a projection lens, and accordingly its cooling system is complicated.

Moreover, considering that a lenticular lens of the screen is suitable for the CRT arranged side by side, light of red (R), green (G) and blue (B) cannot be evenly distributed over the screen if the CRT assembly is structured to the delta-type, and accordingly quality of the image displayed on the screen is relatively low.

### SUMMARY OF THE INVENTION

Accordingly, the present general inventive concept provides a projection television which simplifies a structure of a coupler and enables light of red, green and blue of a cathode ray tube (CRT) assembly to be efficiently and evenly distributed over a screen.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a projection television comprising a cathode ray tube (CRT) assembly, and a screen to form an image thereon by an image beam projected from the CRT assembly, the CRT assembly comprising a plurality of RGB CRTs arranged in a delta-type; a plurality of projection lenses respectively provided in front of each of the RGB CRTs; and a coupler provided between each of the RGB CRTs and each corresponding projection lens to accommodate a first, a second and a third coolant accommodators corresponding to each of the RGB CRTs, wherein at least one of the first, the second and the third coolant accommodators comprises a coolant injection port, and the other coolant accommodators respectively comprise coolant communication holes to communicate with the coolant accommodator in which the coolant injection port is provided.

The projection television may further comprise a bellows provided in the coolant injection port.

The coupler may comprise a front supporter to support a front portion of the RGB CRTs and to accommodate the first, the second and the third coolant accommodators; and a rear supporter coupled to the front supporter to support a rear portion of the RGB CRTs.

The front supporter and the rear supporter may be coupled by a screw.

The screen may comprise a lenticular lens and a fresnel lens, and the lenticular lens may comprise a first lens and a second lens in contact with to each other.

The first lens and the second lens may be crossed each other.

The first lens and the second lens may respectively comprise embossing-type light transmitting parts; and light absorbing parts protruding between the light transmitting parts.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a conventional projection television;

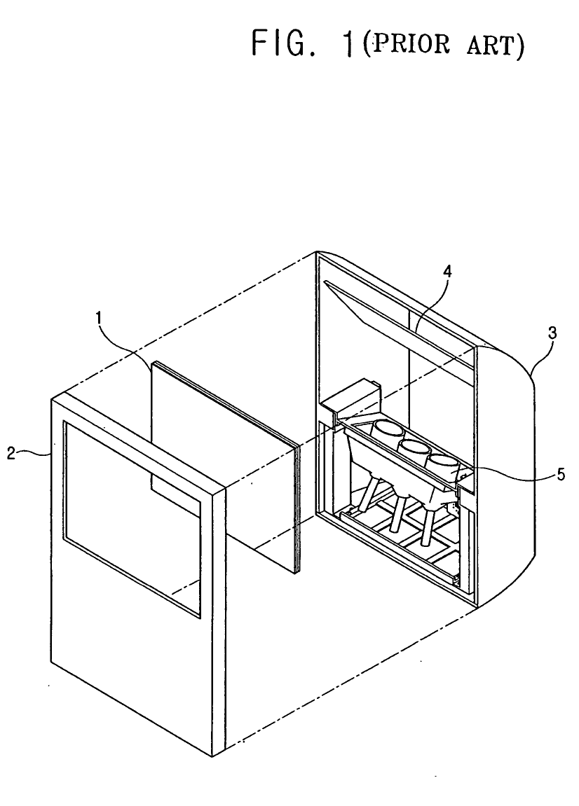

FIG. 2 is a perspective view of a projection television according to the present general inventive concept;

FIG. 3 is a sectional side view of the projection television according to the present general inventive conept;

FIG. 4 is a perspective view of a cathode ray tube (CRT) assembly of the projection television according to the present general inventive concept;

FIG. 5 is an exploded perspective view of the CRT assembly of the projection television according to the present general inventive concept;

FIG. 6 is a perspective view of a coupler of the CRT assembly of the projection television according to the present general inventive concept;

FIG. 7 is a sectional view of the coupler of the CRT assembly of the projection television according to the present general inventive concept;

FIG. 8 is a sectional view of a screen of the projection television according to the present general inventive concept; and

FIG. 9 is a perspective view of a lenticular lens of the projection television according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

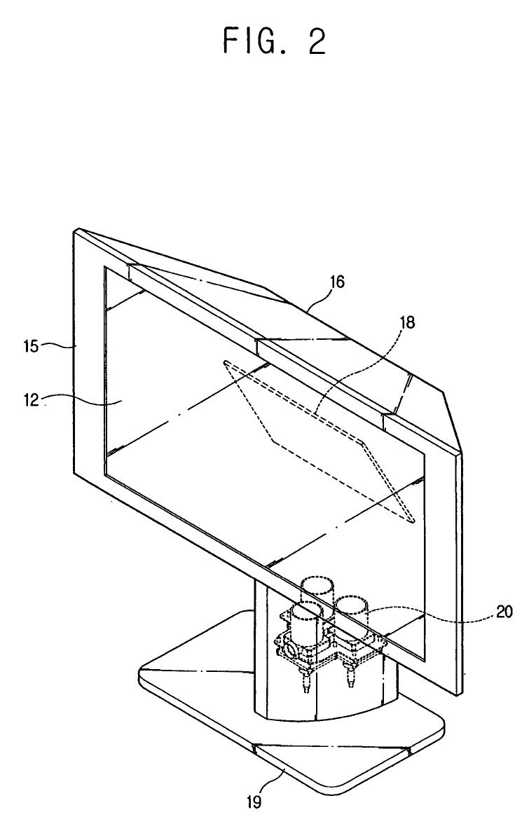

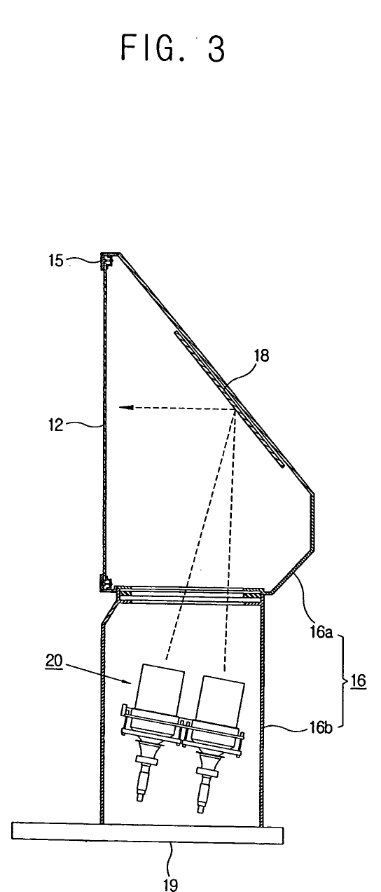

As shown in FIGS. 2 and 3, a projection television according to the present general inventive concept may comprise a screen 12; a mask 15 to support the screen 12; a casing 16 coupled to a rear side of the mask 15; a reflection mirror 18 provided in an inner rear of the casing 16; and a cathode ray tube (CRT) assembly 20 provided in a lower portion of the casing 16.

The screen 12 may be supported by a supporting bracket (not shown) at an end thereof, and coupled to a rear side of the mask 15.

The size of the mask 15 may be big enough to cover the screen 12, and thus may form a front appearance of the projection television by having its edge cover outer sides of the screen 12.

The casing 16 may form a side and rear appearance of the projection television, and may be firmly coupled to the mask 15 forming the front appearance by a screw or the like. The casing 16 may comprise an upper casing 16a on which the reflection mirror 18 may be mounted; and a lower casing 16b standing up in a lower portion of the casing 16 to accommodate the CRT assembly 20 therein. The lower casing 16b can be slimmed because the CRT assembly may be structured in a delta type.

On a bottom side of the casing 16 may be provided a print circuit board (not shown) to control the CRT assembly 20, and a supporting plate 19 may be provided in the lower portion of the casing 16 to stably support the casing 16.

The reflection mirror 18 may reflect an image beam projected through the CRT assembly 20 to a rear surface of the screen 12.

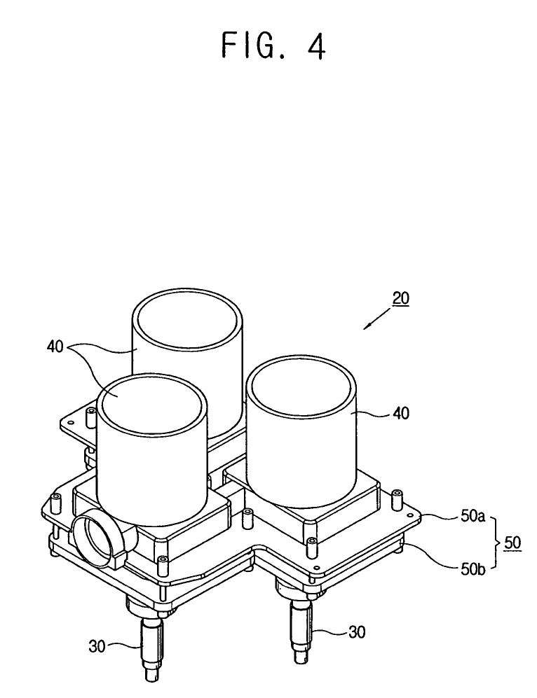

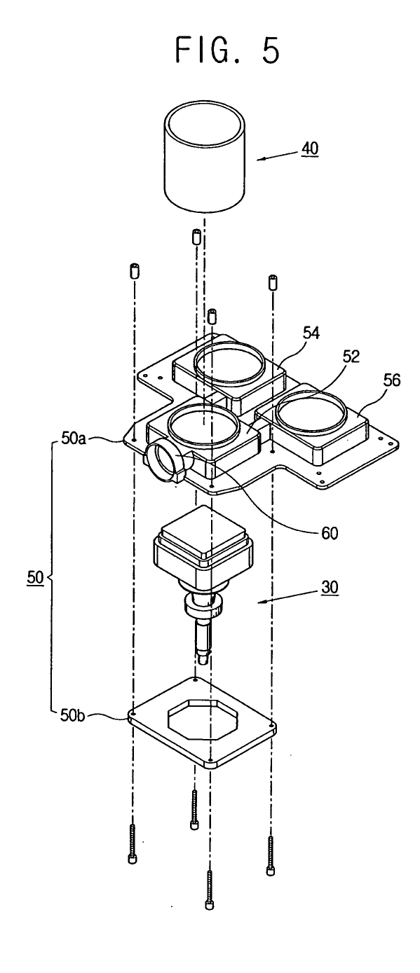

As shown in FIGS. 4 and 5, the CRT assembly 20 of the projection television may comprise a plurality of RGB cathode ray tubes 30 arranged in a delta-type structure; a projection lens 40 provided in front of each of the RGB CRTs 30; and a coupler 50 provided between each of the RGB CRTs 30 and each of the corresponding projection lenses 40.

The respective RGB CRTs 30 and each of the corresponding projection lenses 40 may be in contact with each other and strongly coupled by a coupling device. Each RGB CRT 30 may generate an image beam, and each corresponding projection lens 40 may project the image beam to the reflection mirror 18.

The coupler 50 may support the plurality of RGB CRTs 30 and the projection lenses 40, and may comprise a first, a second and a third coolant accommodators 52, 54, and 56 respectively coupled to each of the RGB CRTs 30 and each of the corresponding projection lenses 40 to accommodate a first, second and third coolants. Further, the coupler 50 may comprise a front supporter 50a to support a front portion of the RGB CRT 30, having the first, the second and the third coolant accommodators 52, 54, and 56 mounted thereon; and a rear supporter 50b coupled to the front supporter 50a to support a rear portion of the RGB CRT 30. The front supporter 50a and the rear supporter 50b may be coupled by a screw or other various coupling devices.

Ethylene glycol or glycerin may be used as the coolant to cool down heat generated from the RGB CRT 30, and the coupler 50 may contain aluminum, which has excellent heat proofing qualities.

In a side of the coupler 50 may be provided a bellows 60 to flexibly respond to a pressure change of the coolant in the first, the second and the third coolant accommodators 52, 54, and 56. In other words, the bellows 60 may be flexible and durable to expansion and contraction of the coolant with respect to a temperature change so as to sustain the pressure of the coolant.

Accordingly, the bellows 60 may be made of a rubbery material considering durability and elasticity thereof, and can be selectively structured as a well-known form as necessary.

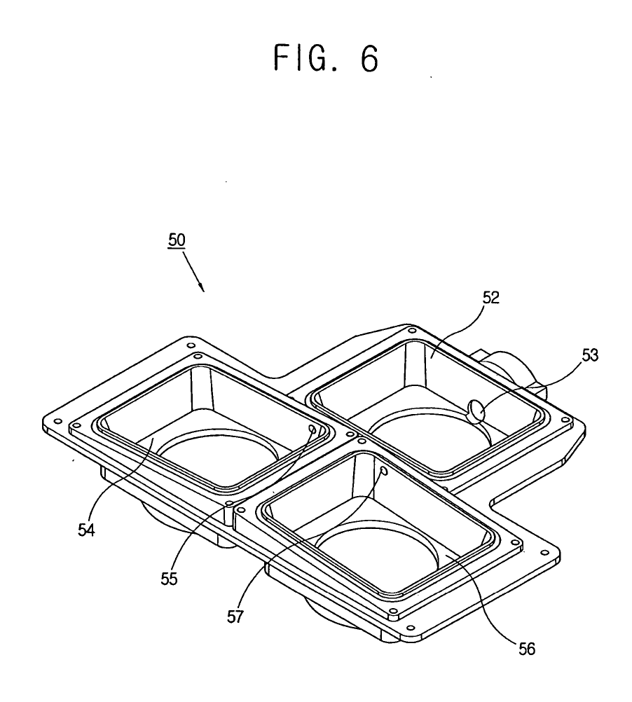

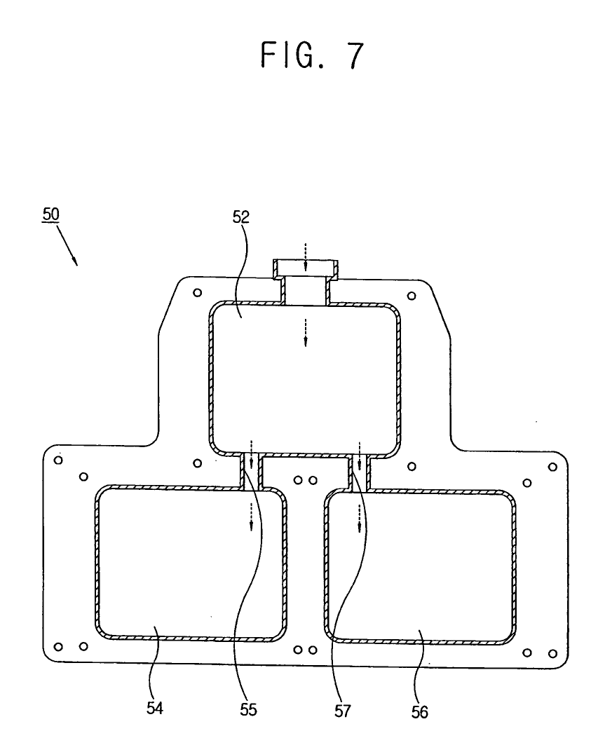

As shown in FIGS. 6 and 7, the coupler 50 may comprise the first, the second and the third coolant accommodators 52, 54, and 56 which may be adjacently arranged to each other to form a triangular shape. The first coolant accommodator 52 may comprise a coolant injection port 53 provided in a side thereof to inject the coolant, and the second and the third coolant accommodators 54 and 56 may respectively comprise coolant communication holes 55 and 57 to communicate with the first coolant accommodator 52. Hence, after the first coolant accommodator 52 is filled with a given amount of the coolant injected through the coolant injection port 53, the coolant exceeding the given amount may be respectively injected to the second and the third coolant accommodators 54 and 56 through the coolant communication holes 55 and 57.

Meanwhile, the coolant injection port 53 may be provided in any one of the first, the second, and the third coolant accommodators 52, 54, and 56, and the coolant communication holes 55 and 57 provided in the other two thereof.

A communication structure between the first, the second and the third coolant accommodators 52, 54, and 56 may vary as long as the coolant is evenly distributed to the respective coolant accommodators 52, 54, and 56 through the communication structure.

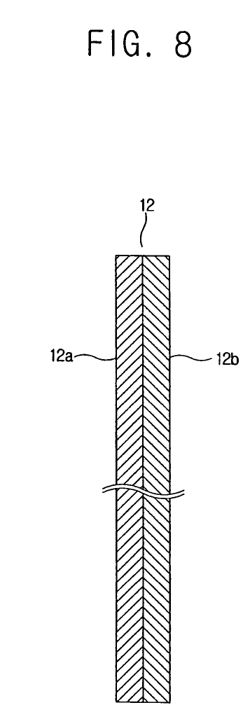

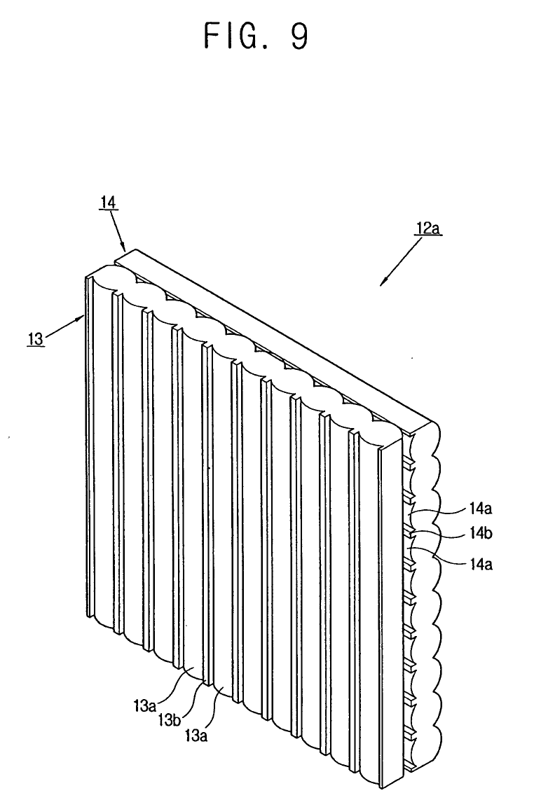

As shown in FIGS. 8 and 9, the screen 12 may comprise a multi-lens structure having a lenticular lens 12a and a fresnel lens 12b. The lenticular lens 12a may comprise a first lens 13 and a second lens 14 which may be coupled each other while being crossed. The first lens 13 and the second lens 14 may respectively comprise embossing-type light transmitting parts 13a and 14a; and light absorbing parts 13b and 14b protruding to absorb external light between the light transmitting parts 13a and 14a.

The light transmitting parts 13a and 14a may uniformly distribute the light of red, green and blue along vertical and horizontal directions of the screen 12, and the light absorbing parts 13b and 14b may absorb the external light, such as sunlight and natural/artificial lighting, so as to prevent contrast of an image from being decreased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A projection television comprising:
a cathode ray tube (CRT) assembly comprising,
a plurality of RGB CRTs arranged in a delta-type,
a plurality of projection lenses respectively provided in front of each of the RGB CRTs, and
a coupler provided between each of the RGB CRTs and each corresponding projection lens to accommodate a first, a second and a third coolant accommodators corresponding to each of the RGB CRTs; and
a screen to form an image thereon by an image beam projected from the CRT assembly,
wherein at least one of the first, the second and the third coolant accommodators comprises a coolant injection port, and the other coolant accommodators respectively comprise coolant communication holes communicating with the coolant accommodator in which the coolant injection port is provided.

2. The projection television according to claim 1, further comprising:
a bellows provided in the coolant injection port.

3. The projection television according to claim 1, wherein the coupler comprises a front supporter to support a front portion of the RGB CRTs and to accomodate the first, the second and the third coolant accommodators; and a rear supporter coupled to the front supporter to support a rear portion of the RGB CRTs.

4. The projection television according to claim 3, wherein the front supporter and the rear supporter are coupled by a screw.

5. The projection television according to claim 2, wherein the coupler comprises a front supporter to support a front portion of the RGB CRTs and to accommodate the first, the second and the third coolant accommodators; and a rear supporter coupled to the front supporter to support a rear portion of the RGB CRTs.

6. The projection television according to claim 5, wherein the front supporter and the rear supporter are coupled by a screw.

7. The projection television according to claim 1, wherein the screen comprises a lenticular lens and a fresnel lens, the lenticular lens comprising a first lens and a second lens contacting each other.

8. The projection television according to claim 7, wherein the first lens and the second lens are crossed each other.

9. The projection television according to claim 8, wherein the first lens and the second lens respectively comprise embossing-type light transmitting parts and light absorbing parts protruding between the light transmitting parts.

10. The projection television according to claim 2, wherein the screen comprises a lenticular lens and a fresnel lens, the lenticular lens comprising a first lens and a second lens contacting each other.

11. The projection television according to claim 10, wherein the first lens and the second lens are crossed each other.

12. The projection television according to claim 11, wherein the first lens and the second lens respectively comprise embossing-type light transmitting parts and light absorbing parts protruding between the light transmitting parts.

13. A projection television comprising:
a cathode ray tube (CRT) unit including a first light source, a second light source, and a third light source arranged in a triangular pattern; a first projection lens, a second projection lens, and a third projection lens arranged in the triangular pattern to project light of the first light source, the second light source, and the third light source, respectively; and a coupling unit to simultaneously couple the first, second, and third light sources and the corresponding lenses, and cool the CRT unit;
a screen to display an image of the CRT unit; and
a reflecting mirror to reflect the light projected from the first, second, and third projection lenses to the screen to form the image.

14. The projection television according to claim 13, wherein the coupling unit comprises:
a first coolant reservoir disposed between the first light source and the first projection lens;
a second coolant reservoir disposed between the second light source and the second projection lens;
a third coolant reservoir disposed between the third light source and the third projection lens;
an opening formed in one of the first, second, and the third coolant reservoirs to allow coolant to be input from an external source;
a first hole and a second holes formed between the one of the first, second, and third coolant reservoirs with the opening and each of the remaining ones thereof, respectively, to allow the coolant to flow evenly from the one of the first, second, and third coolant reservoirs with the opening into the remaining ones thereof.

15. The projection television according to claim 14, wherein the remaining ones of the first, second, and third coolant reservoirs do not receive the coolant from the external source, but receive the coolant through the one of the first, second, and third coolant reservoirs.

16. The projection television according to claim 14, wherein the remaining ones of the first, second, and third coolant reservoirs communicate with each other through the one of the first, second, and third coolant reservoirs with the opening.

17. The projection television according to claim 14, wherein the first, second, and third coolant reservoirs are arranged in the triangular pattern.

18. The projection television according to claim 17, wherein the first coolant reservoir comprises a first side formed with the opening, and a second side disposed adjacent to the second and third coolant reservoirs and formed with the first and seconds holes.

19. The projection television according to claim 18, wherein the first hole is formed to penetrate a first spot in the second side of the first coolant reservoir and a corresponding adjacent spot in the second coolant reservoir, and the second hole is formed to penetrate a second spot in the second side of the first coolant reservoir and a corresponding adjacent spot in the third coolant reservoir.

20. The projection television according to claim 14, wherein the coupling unit further comprises a bellows disposed at the opening to flexibly respond to a pressure change of the coolant in the first, second, and third coolant reservoirs.
